(19) United States
(12) Patent Application Publication
(10) Pub. No.: US 2010/0009258 A1
(43) Pub. Date: Jan. 14, 2010

(54) Negative electrode for lithium ion secondary battery, method for producing the same, lithium ion secondary battery and method for producing the same

(75) Inventors: Masaki Hasegawa, Osaka (JP); Yasuhiko Bito, Osaka (JP)

Correspondence Address: MCDERMOTT WILL & EMERY LLP, 600 13TH STREET, NW, WASHINGTON, DC, 20005-3096, US

(73) Assignee: MATSUSHITA ELECTRIC INDUSTRIAL CO., LTD

(21) Appl. No.: 11/794,580

(22) PCT Filed: Nov. 16, 2005
(86) PCT No.: PCT/JP05/21034

§ 371 Date: Jul. 2, 2007

(30) Foreign Application Priority Data
Jan. 14, 2005 (JP) 2005-007395

(51) Int. Cl. H01M 4/62; H01M 10/00; H01M 4/04

(52) U.S. Cl. 429/217; 29/623.2; 427/58

(57) ABSTRACT

A negative electrode for a lithium ion secondary battery, including: a negative electrode material mixture including an active material powder capable of reversibly absorbing and desorbing lithium, and a binder, wherein the active material includes at least one element selected from the group consisting of Si and Sn, and the binder includes at least one selected from the group consisting of an ethylene-acrylic acid copolymer and an ethylene-methacrylic acid copolymer.

### TECHNICAL FIELD

The present invention relates to a lithium ion secondary battery, and particularly relates to a negative electrode thereof.

### BACKGROUND ART

Lithium ion secondary batteries have a high voltage and a high energy density. Recently, lithium ion secondary batteries have been used as the main power sources for various devices, including, for example, mobile communication devices and portable electronic devices. With the size reduction and the performance enhancement of these devices, there has also been a demand for the performance enhancement of lithium ion secondary batteries, and many studies are being conducted.

A variety of materials have been suggested and studied as the positive electrode active material and the negative electrode active material of lithium ion secondary batteries. For the negative electrode active material, carbon materials and aluminum alloys, for example, have been put to practical use. Among them, carbon materials exhibit the highest performance, and are being widely used.

However, carbon materials have a theoretical capacity of about 370 mAh/g, and a capacity close to the theoretical capacity has already been utilized. Thus, it is difficult to achieve a further significant increase in the energy density.

Therefore, in an attempt to achieve a further increase in the capacity of lithium ion secondary batteries, use of various new materials as the negative electrode active material has been investigated. For example, metals such as silicon and tin, and alloys or oxides including silicon or tin have been suggested (see Patent Documents 1 and 2).

However, active materials comprising the above-described new materials undergo a great volume change resulting from absorption and desorption of lithium during charge/discharge. In a charged state, in which the negative electrode absorbs lithium, the volume of the active material increases, and the negative electrode expands accordingly. On the contrary, in a discharged state, in which lithium is desorbed, the volume of the active material decreases, and the negative electrode also contracts accordingly.

In the case of producing an electrode using an active material comprising a metal, an alloy or an oxide, an electrode material mixture including an active material powder and a binder as its essential components is generally prepared. An electrode can be obtained by causing the electrode material mixture to be carried on a current collector made of a metal foil.

Here, a resin material is used for the binder. The binder serves to bond active material particles together in the electrode material mixture, and also to bond the electrode material mixture and the current collector together. Thus, the performance of the electrode is greatly influenced by the performance of the binder. When the binding force of the binder is low, the adhesion between the active material particles and the adhesion between the electrode material mixture and the current collector are reduced. Accordingly, the current collection performance of the electrode is reduced, degrading the electrode characteristics.

In the case of using a material that undergoes a large volume change during charge/discharge as the active material, a large stress is applied to the binder included in the electrode material mixture. Therefore, the binder is required to have a strong binding force. In order to meet this requirement, use of various resin materials has been investigated. For example, use of polyacrylic acid having high adhesiveness has been suggested (see Patent Document 3).

Patent Document 1: Laid-Open Patent Publication No. Hei 7-29602

Patent Document 2: Laid-Open Patent Publication No.

Patent Document 3: Laid-Open Patent Publication No. Hei 9-289022

### DISCLOSURE OF THE INVENTION

### Problem to be Solved by the Invention

In general, the adhesiveness of a resin material is exerted by the interaction between the functional groups of the resin material and the surface of an object. Since polyacrylic acid has many carboxyl groups as its functional groups, it has strong adhesiveness and is also chemically stable. Therefore, polyacrylic acid exhibits good characteristics as the binder. Polyacrylic acid exhibits relatively good adhesiveness also for an active material that undergoes a great volume change during charge/discharge. However, on the other hand, polyacrylic acid is solid, and poor in flexibility. Therefore, when subjected to repeated charge/discharge cycles, it cannot endure the stress resulting from the volume change of the active material, so that the binding structure of the active material particles is gradually destroyed, thus degrading the battery characteristics. The degradation of the charge/discharge cycle characteristics is particularly significant at a low temperature at which the flexibility of the resin material is reduced.

### Means for Solving the Problem

The present invention relates to a negative electrode for a lithium ion secondary battery, comprising: a negative electrode material mixture including an active material powder capable of reversibly absorbing and desorbing lithium, and a binder, wherein the active material includes at least one element selected from the group consisting of Si and Sn, and the binder includes at least one selected from the group consisting of an ethylene-acrylic acid copolymer and an ethylene-methacrylic acid copolymer.

As the active material, it is preferable to use, for example, an alloy of Si and a transition metal, or an oxide including at least one element selected from the group consisting of Si and Sn. Preferably, the transition metal constituting the alloy is at least one selected from the group consisting of Ti, Fe, Co, Ni and Cu.

The content of an acrylic acid unit included in the ethylene-acrylic acid copolymer is preferably 4 mol % to 80 mol %.

The content of a methacrylic acid unit included in the ethylene-methacrylic acid copolymer is preferably 4 mol % to 80 mol %.

The content of the binder in the negative electrode material mixture is preferably 0.5 wt % to 20 wt %.

The present invention also relates to a lithium ion secondary battery comprising: a chargeable and dischargeable positive electrode; the above-described negative electrode; and a non-aqueous electrolyte.

The present invention also relates to a method for producing a negative electrode for a lithium ion secondary battery, the method comprising: (i) preparing a slurry by mixing, with a liquid dispersion medium, a negative electrode material mixture including an active material powder capable of reversibly absorbing and desorbing lithium, and a binder, wherein the active material includes at least one element selected from the group consisting of Si and Sn, and the binder includes at least one selected from the group consisting of an ethylene-acrylic acid copolymer and an ethylene-methacrylic acid copolymer; (ii) applying the slurry to a substrate, followed by drying, thereby forming a negative electrode material mixture layer; and (iii) rolling the negative electrode material mixture under heating, or rolling the negative electrode material mixture followed by heating. The temperature for the heating is preferably not less than 60° C. and not more than 150° C.

Here, the step (ii) includes, for example, the step of applying a slurry to the negative electrode current collector, followed by drying, thereby causing the negative electrode material mixture layer to be carried on a current collector, and the step (iii) includes, for example, the step of rolling the negative electrode material mixture layer carried on the current collector under heating, or rolling the negative electrode material mixture carried on the current collector followed by heating.

The present invention also relates to a method for producing a lithium ion secondary battery, the method comprising: (a) forming an electrode group comprising a positive electrode and the above-described negative electrode; (b) housing the electrode group in a battery case having an opening; (c) impregnating the electrode group with a non-aqueous electrolyte in the battery case; (d) sealing the opening of the battery case, thereby forming a battery; and (e) heating the battery in a charged state. Here, the temperature for the heating is preferably not less than 60° C. and not more than 90° C. In addition, the step of heating the battery in a charged state is performed before shipment of the battery. The heating is preferably performed at the time of the initial charging of the sealed battery, and is preferably performed until at least the second charging.

### EFFECT OF THE INVENTION

By including at least one selected from the group consisting of an ethylene-acrylic acid copolymer and an ethylene-methacrylic acid copolymer as the binder in a negative electrode that includes an active material powder capable of reversibly absorbing and desorbing lithium and including at least one element selected from the group consisting of Si and Sn, it is possible to provide a lithium ion secondary battery having excellent cycle characteristics especially at a low temperature.

### BRIEF DESCRIPTION OF THE DRAWING

FIG. 1 is a vertical cross-sectional view showing a battery used for evaluation tests for a negative electrode for a lithium ion secondary battery according to the present invention.

### BEST MODE FOR CARRYING OUT THE INVENTION

A negative electrode for a lithium ion secondary battery according to the present invention includes an active material that has a high capacity and undergoes great expansion and contraction during charge/discharge. The active material that undergoes great expansion and contraction during charge/discharge includes at least one element selected from the group consisting of Si and Sn.

In the case of using an active material that undergoes great expansion and contraction, it is necessary to use a resin material having excellent adhesiveness as the binder. However, when a resin material such as polyacrylic acid is used, its low flexibility causes a problem in the cycle characteristics especially at a low temperature.

On the other hand, the negative electrode according to the present invention includes at least one selected from the group consisting of an ethylene-acrylic acid copolymer and an ethylene-methacrylic acid copolymer as the binder. Since an ethylene-acrylic acid copolymer and an ethylene-methacrylic acid copolymer contain an ethylene unit, they have excellent flexibility.

While polyethylene composed only of ethylene units has poor flexibility when its crystallinity is high, polyethylene having a low crystallinity has excellent flexibility. In the case of an ethylene-acrylic acid copolymer and an ethylene-methacrylic acid copolymer, the crystallinity of the copolymers are low due to the influence of the acrylic acid unit and the methacrylic acid unit, respectively. Accordingly, these copolymers have high flexibility. Furthermore, these copolymers contain an acrylic acid unit and a methacrylic acid unit, respectively, and therefore also have high adhesiveness.

The ethylene-acrylic acid copolymer has a structure represented by the following formula (1):

{(CH₂CH₂)ₙ—(CH(COOH)CH₂)ₘ}ₖ (1)

In the formula (1), n, m and k are arbitrary integers.

The ethylene-methacrylic acid copolymer has a structure represented by the following formula (2):

{(CH₂CH₂)ₙ—(C(CH)₃(COOH)CH₂)ₘ}ₖ (2)

In the formula (2), n, m and k are arbitrary integers.

As the negative electrode active material including at least one element selected from the group consisting of Si and Sn, it is possible to use, for example, metal simple substances (a Si simple substance, a Sn simple substance), alloys (a Si alloy, a Sn alloy), oxides (a Si oxide, a Sn oxide) and nitrides (a Si nitride, a Sn nitride).

It is preferable that the metallic element included in the alloy, other than silicon or tin, is a metallic element that does not form an alloy with lithium. The metallic element that does not form an alloy with lithium may be any chemically stable electron conductor, and titanium, copper, nickel or the like are preferable, for example. One of these may be included singly in the alloy, or two or more of them may be included in the alloy at the same time. In the case of a Ti—Si alloy, for example, the molar ratio of Ti/Si is preferably 0<Ti/Si<2, and particularly preferably 0.1≦Ti/Si≦1.0. In the case of a Cu—Si alloy, the molar ratio of Cu/Si is preferably 0<Cu/Si<4, and particularly preferably 0.1≦Cu/Si≦2.0. In the case of a Ni—Si alloy, the molar ratio of Ni/Si is preferably 0<Ni/Si<2, and particularly preferably 0.1≦Ni/Si≦1.0.

It is preferable that the Si oxide has a composition represented by the general formula SiOₓ (wherein 0<x<2). Here, it is further preferable that the value of x that represents the content of the oxygen element is 0.01≦x≦1. It is preferable that the Sn nitride has a composition represented by the general formula SnN_{y} (wherein 0<y<4/3). Here, it is further preferable that the value of y that represents the content of the nitrogen element is 0.01≦y≦1.

The negative electrode active materials may be used singly, or in combination of two or more of them. The average particle diameter of the negative electrode active material is preferably 1 to 50 μm.

In the case of using a powdered material as the active material, the negative electrode is generally produced in the following manner.

First, a negative electrode material mixture including an active material powder and a binder as its essential components is mixed with a liquid dispersion medium to prepare a slurry. Next, the slurry is applied to a negative electrode current collector, followed by drying to remove the dispersion medium, thereby causing the negative electrode material mixture layer to be carried on the current collector. Then, the density of the negative electrode material mixture layer is controlled by rolling the negative electrode material mixture layer carried on the current collector.

The rolling is performed for increasing the density of the negative electrode. During rolling, the thickness of the negative electrode material mixture layer changes greatly. Accordingly, a large stress is also applied to the binder included in the negative electrode material mixture. A binder having poor flexibility, such as polyacrylic acid, cannot endure this stress, so that adhesion is partly broken and the resin material is also partly destroyed. This reduces the function of the binder, and degrades the current collection performance during charge/discharge, resulting in degraded cycle characteristics. Furthermore, the stress also remains at the portion of the binder that has not been destroyed, so that the thickness of the electrode material mixture layer tends to be restored. This makes designing of the battery structure difficult, and also promotes the expansion of the electrode material mixture during charging.

However, since the ethylene-acrylic acid copolymer and the ethylene-methacrylic acid copolymer have excellent flexibility, the function of the binder tends not to be reduced even if the negative electrode material mixture is rolled. Furthermore, the ethylene-acrylic acid copolymer and the ethylene-methacrylic acid copolymer have excellent thermoplasticity, and exhibit even more excellent adhesiveness through heating. Accordingly, it is possible to roll the negative electrode material mixture under heating, or to roll the negative electrode material mixture followed by heating, thereby reproducing the destroyed binding structure, and also alleviating the residual stress. However, the effect of the invention can also be sufficiently achieved without performing heating. Additionally, the heating of the negative electrode material mixture may be performed at any time after the negative electrode material mixture is carried on the current collector.

The heating temperature for the negative electrode material mixture is preferably 60° C. to 150° C., and particularly preferably 80° C. to 130° C. When the heating temperature is less than 60° C., the softening of the copolymer is insufficient, so that the effect of heating is reduced. On the other hand, when the heating temperature exceeds 150° C., fluidization of the resin component occurs in the negative electrode material mixture, thus possibly making the negative electrode material mixture nonuniform.

In general, a lithium ion secondary battery is produced in the following manner.

First, an electrode group including a positive electrode and a negative electrode is formed. For example, a cylindrical electrode group is formed by winding a positive electrode and a negative electrode, with a separator interposed therebetween. The electrode group is housed in a battery case having an opening. Next, the electrode group is impregnated with a non-aqueous electrolyte in the battery case, and then the opening of the battery case is sealed.

Here, the ethylene-acrylic acid copolymer and the ethylene-methacrylic acid copolymer have a relatively low softening temperature of not less than 60° C. Therefore, the stress applied to the binder due to the expansion of the negative electrode can be reduced by heating the sealed battery. This makes it possible to suppress degradation of the charge/discharge cycle characteristics. The effect of the invention can also be achieved sufficiently without performing heating. Additionally, the heating of the battery is performed preferably in a charged state of the battery, and particularly preferably during the initial charging.

The heating temperature for the battery is preferably 60° C. to 90° C., and particularly preferably 70° C. to 90° C. When the heating temperature is less than 60° C., the softening of the copolymer is insufficient, so that the effect of heating is reduced. On the other hand, when the heating temperature exceeds 90° C., the side reaction between the constituent materials of the battery (e.g., the non-aqueous electrolyte and the electrode active material) is promoted, thus possibly degrading the battery characteristics.

The content of an acrylic acid unit included in the ethylene-acrylic acid copolymer is preferably 4 mol % to 80 mol %, and more preferably 10 to 60 mol %. The content of a methacrylic acid unit included in the ethylene-methacrylic acid copolymer is preferably 4 mol % to 80 mol %, and more preferably 10 to 60 mol %. The flexibility of the copolymer is gradually reduced when the content of the acrylic acid unit in the ethylene-acrylic acid copolymer exceeds 80 mol %, and the adhesiveness is gradually reduced when it is less than 4 mol %. Similarly, the flexibility of the copolymer is gradually reduced when the content of the methacrylic acid unit in the ethylene-methacrylic acid copolymer exceeds 80 mol %, and the adhesiveness is gradually reduced when it is less than 4 mol %. When the copolymerization ratio of the ethylene unit and the acrylic acid unit, and the copolymerization ratio of the ethylene unit and the methacrylic acid unit are within the above-described range, the effect of the present invention is further increased. In addition, the weight- (or number-) average molecular weights of the ethylene-acrylic acid copolymer and the ethylene-methacrylic acid copolymer are 10000 to 1000000.

The content of the binder in the negative electrode material mixture is preferably 0.5 wt % to 20 wt %. When the content of the binder exceeds 20 wt %, the ratio of the portion of the active material particle surface that is covered by the binder increases, so that the charge/discharge reactivity may be reduced. On the other hand, when the content of the binder is less than 0.5 wt %, the adhesiveness may be reduced. When the content of the binder is within the above-described range, the effect of the present invention is further increased.

As the material of the negative electrode current collector, it is possible to use an electron conductor that does not cause any chemical reaction in the battery. For example, it is possible to use stainless steel, nickel, copper, titanium, carbon and a conductive resin. It is also possible to use a sheet obtained by attaching carbon, nickel or titanium to the surface of a foil of copper or stainless steel. It is also possible to use a current collector obtained by forming a conductive layer on the surface of a resin sheet that does not have electron conductivity. As the material of the resin sheet, it is possible to use polyethylene terephthalate, polyethylene naphthalate and polyphenylene sulfide, for example. Among them, a copper foil or a copper alloy foil is preferable in terms of the cost, workability and stability.

The shape of the negative electrode is preferably a sheet form. A sheet-like negative electrode can be obtained by causing the negative electrode material mixture layer to be carried on a sheet-like current collector, or molding the negative electrode material mixture in the form of a sheet. The sheet-like negative electrode can be further processed into a predetermined shape (e.g., a disc shape or a band shape).

Various optional components may be included in the negative electrode material mixture. Examples of the optional components include a thickener, a conductive agent and a dispersing agent. When the liquid dispersion medium is water, a water-soluble resin such as carboxymethyl cellulose (CMC) can be used as the thickener. When the liquid dispersion medium is an organic solvent such as N-methyl-2-pyrrolidone, a water-insoluble resin such as polyvinylidene fluoride (PVDF) can be used as the thickener.

As the conductive agent, it is possible to use, for example, graphite, carbon black, conductive fibers, a metal powder and an organic conductive material. As the graphite, it is possible to use a natural graphite (e.g., flake graphite), an artificial graphite and an expanded graphite, for example. As the carbon black, it is possible to use acetylene black, Ketjen Black, channel black, furnace black, lamp black and thermal black, for example. As the conductive fibers, it is possible to use carbon fibers and metal fibers, for example. As the metal powder, it is possible to use a copper powder and a nickel powder, for example. As the organic conductive material, it is possible to use a polyphenylene derivative, for example. One of these may be used singly, or two or more of them may be used as a mixture. Among them, carbon black, which comprises fine particles and has high conductivity, is particularly preferable. There is no particular limitation with respect to the amount of the conductive agent. The amount of the conductive agent is preferably 1 to 30 parts by weight per 100 parts by weight of the negative electrode active material.

There is no particular limitation with respect to a positive electrode, a non-aqueous electrolyte, a separator and the like that are combined with the negative electrode, and it is possible to use any known positive electrode and non-aqueous electrolyte without any particular limitation.

Like the negative electrode, the positive electrode can be obtained, for example, by causing a positive electrode material mixture layer to be carried on a sheet-like current collector, or molding a positive electrode material mixture in the form of a sheet. The positive electrode material mixture includes a positive electrode active material as its essential component, and includes a binder, a conductive agent, a thickener and the like as its optional components. As the positive electrode active material, it is possible to use, for example, a lithium-containing oxide. For example, it is preferable to use LiₓCoO₂, LiₓMnO₂, LiₓNiO₂, LiCrO₂, αLiFeO₂, LiVO₂, LiₓCo_{y}Ni_{1-y}O₂, LiₓCo_{y}M_{1-y}O_{z}, LiₓNi_{1-y}O_{z}, LiₓMn₂O₄ and LiₓMn_{2-y}M_{y}O₄ (wherein M is at least one selected from the group consisting of Na, Mg, Sc, Y, Mn, Fe, Co, Ni, Cu, Zn, Al, Cr, Pb, Sb and B, x is 0 to 1.2, y is 0 to 0.9, and z is 2.0 to 2.3). These may be used singly, or in combination of two or more of them. In addition, the above-described value of x increases or decreases with charge/discharge. It is preferable that the average particle diameter of the positive electrode active material is 1 μm to 30 μm.

As the non-aqueous electrolyte, it is preferable to use a non-aqueous solvent in which a lithium salt is dissolved. Although there is no particular limitation with respect to the amount of the lithium salt dissolved in the non-aqueous solvent, the concentration of the lithium salt is preferably 0.2 to 2 mol/L, and more preferably 0.5 to 1.5 mol/L.

As the non-aqueous solvent, it is possible to use, for example, cyclic carbonates such as ethylene carbonate (EC), propylene carbonate (PC) and butylene carbonate (BC); non-cyclic carbonates such as dimethyl carbonate (DMC), diethyl carbonate (DEC) and ethylmethyl carbonate (EMC) and dipropyl carbonate (DPC); aliphatic carboxylic acid esters such as methyl formate, methyl acetate, methyl propionate and ethyl propionate; lactones such as γ-butyrolactone, γ-valerolactone; non-cyclic ethers such as 1,2-dimethoxyethane (DME), 1,2-diethoxyethane (DEE) and ethoxymethoxyethane (EME); and cyclic ethers such as tetrahydrofuran and 2-methyltetrahydrofuran. Although these may be used singly, it is preferable to use two or more of them as a mixture.

Examples of the lithium salt dissolved in the non-aqueous solvent include LiClO₄, LiBF₄, LiPF₆, LiAlC₄, LiSbF₆, LiSCN, LiCl, LiCF₃SO₃, LiCF₃CO₂, Li(CF₃SO₂)₂, LiAsF₆, LiN(CF₃SO₂)₂, LiB₁₀Cl₁₀, LiCl, LiBr, LiI and a lithium imide salt. These may be used singly, or in combination of two or more of them.

Various additives can be added to the non-aqueous electrolyte in order to improve the charge/discharge characteristics of the battery. As the additive, it is preferable to use at least one selected from the group consisting of vinylene carbonate, vinyl ethyl carbonate and fluorobenzene, for example.

For the separator, it is preferable to use a sheet (a microporous film) comprising a polymer. As the polymer, it is possible to use polyethylene, polypropylene, polyvinylidene fluoride, polyvinylidene chloride, polyacrylonitrile, polyacrylamide, polytetrafluoroethylene, polysulfone, polyether sulfone, polycarbonate, polyamide, polyimide, polyether (polyethylene oxide or polypropylene oxide), cellulose (carboxymethyl cellulose or hydroxy propyl cellulose), poly(meth)acrylic acid and poly(meth)acrylic acid ester, for example.

The microporous film may be a multilayer film constituted by plural layers. In particular, a microporous film comprising polyethylene, polypropylene, polyvinylidene fluoride or the like is preferable. The thickness of the separator is preferably 10 μm to 30 μm, for example.

There is no particular limitation with respect to the shape of the battery. The present invention can be applied to, for example, coin-shaped, sheet-shaped, cylindrical and square batteries. The present invention can also be applied to large batteries used for electric vehicles and the like. The present invention can also be applied to batteries having a laminated structure obtained by laminating plural positive electrodes and negative electrodes, with separators respectively interposed therebetween.

In the following, the present invention is specifically described based on examples, but the present invention is not limited to these examples.

### Example 1

### (i) Production of Negative Electrode

A Ti—Si alloy (Ti: 37 wt %, Si 63 wt %) serving as a negative electrode active material was prepared by a mechanical alloying process. An analysis of the resulting alloy by an electron diffraction method using a transmission electron microscope apparatus confirmed that it was an alloy comprising two phases of TiSi₂ and Si.

A negative electrode material mixture including the Ti—Si alloy powder (average particle diameter 10 μm), a powder of a binder and a conductive agent was sufficiently mixed with water serving as a liquid dispersion medium to prepare a negative electrode material mixture slurry. Acetylene black was used as the conductive agent. The resin materials listed in Table 1 were used as the binder.

Here, the content of an acrylic acid unit included in the ethylene-acrylic acid copolymer, the content of a methacrylic acid unit included in the ethylene-methacrylic acid copolymer, the content of an acrylic acid unit included in the styrene-acrylic acid copolymer and the content of a methacrylic acid unit included in the styrene-methacrylic acid copolymer were each set to 20 mol %. In addition, the weight-average molecular weight of each of the copolymers was set to 200000.

Except for the case where polyacrylic acid was used as the binder, an alkaline slurry was obtained by adding ammonia water to the dispersion medium in order to obtain a negative electrode material mixture slurry exhibiting a good dispersion state.

The content of each of the binders in the total of the Ti—Si alloy, the binder and the conductive agent was set to 10 wt %. In addition, the amount of the conductive agent was set to 20 parts by weight per 100 parts by weight of the Ti—Si alloy.

The negative electrode material mixture slurry was applied to one side of a negative electrode current collector made of a rolled copper foil having a thickness of 12 μm, and the whole was dried at 60° C. to cause the negative electrode material mixture to be carried on the current collector. Thereafter, the negative electrode material mixture carried on the current collector was rolled at room temperature (25° C.) to obtain a negative electrode sheet. The obtained negative electrode sheet was cut into a disc with a diameter of 1.9 cm to give a negative electrode. The amount of the negative electrode material mixture carried on the current collector was controlled such that the weight of the active material included in the disc-like negative electrode was 15 mg.

The negative electrodes including polyacrylic acid, an ethylene-acrylic acid copolymer, an ethylene-methacrylic acid copolymer, a styrene-acrylic acid copolymer and a styrene-methacrylic acid copolymer were named Negative electrodes A1, A2, A3, A4 and A5, respectively.

### (ii) Production of Positive Electrode

A positive electrode material mixture including LiCoO₂ serving as a positive electrode active material, acetylene black serving as a conductive agent and polytetrafluoroethylene (PTFE) serving as a binder was sufficiently mixed with water serving as a liquid dispersion medium to prepare a positive electrode material mixture slurry.

The positive electrode material mixture slurry was applied to one side of a positive electrode current collector made of an aluminum foil having a thickness of 20 μm using a doctor blade, and the whole was dried to cause the positive electrode material mixture to be carried on the current collector. Thereafter, the positive electrode material mixture carried on the current collector was rolled to obtain a positive electrode sheet. The obtained positive electrode sheet was cut into a disc with a diameter of 1.8 cm to give a positive electrode.

The thickness of the positive electrode was controlled so as to provide a proper balance in capacity with the negative electrode. Here, the capacity of the positive electrode was in excess, and the battery capacity was regulated by the negative electrode. The thickness of the positive electrode was controlled by changing the gap width of the doctor blade.

### (iii) Production of Coin-Shaped Battery

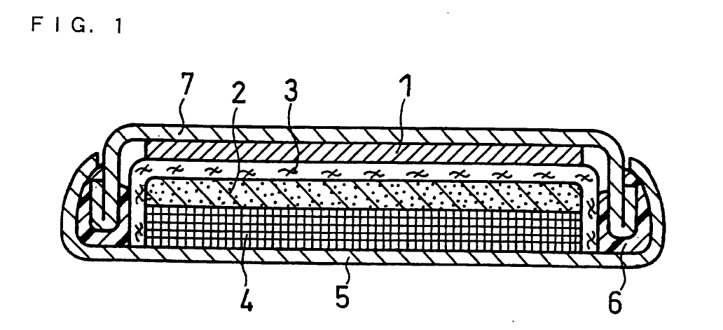

A coin-shaped battery as shown in FIG. 1 was produced using each of the negative electrodes and the positive electrodes. A negative electrode 1 and a positive electrode 2 were placed upon each other, with a separator 3 made of a porous polyethylene sheet interposed therebetween, thus obtaining an electrode group. Here, a positive electrode material mixture layer and a negative electrode material mixture layer were disposed facing each other, with the separator 3 interposed therebetween. The electrode group was installed in a battery case 5 in which a spacer 4 for adjusting the thickness was disposed, with the positive electrode placed at the lower side. As the material of the spacer, aluminum that does not react at the positive electrode potential was used. Thereafter, a predetermined amount of a non-aqueous electrolyte was filled into the battery case 5. A solution in which lithium hexafluorophosphate (LiPF₆) was dissolved at a concentration of 1 mol/L in a mixed solvent containing ethylene carbonate and diethyl carbonate at a volume ratio of 1:1 was used as the non-aqueous electrolyte. Thereafter, the opening of the battery case 5 was sealed by a sealing plate 7 provided with a gasket 6 at its periphery, thereby obtaining a 2320 size coin-shaped battery.

The batteries using Negative electrodes A1, A2, A3, A4 and A5 were named Batteries A1, A2, A3, A4 and A5, respectively. Batteries A2 and A3 are the examples, and Batteries A1, A4 and A5 are the comparative examples.

### (iv) Evaluation of Batteries

Each of the obtained batteries was subjected to repeated charging/discharging at a low temperature of 0° C., and the ratio of the discharge capacity at the 100th cycle to the discharge capacity at the 1st cycle (the initial capacity) was determined in percentage as the capacity retention rate. The charging/discharging was performed with a current of 0.5 mA in a voltage range of 2.5 V to 4.2 V. Table 1 shows the initial capacities and the capacity retention rates at the 100th cycle.

TABLE 1

| | | Initial capacity | Capacity retention |
|---|---|---|---|
| Battery | Binder | (mAh) | rate (%) |
| A1 | Polyacrylic acid | 10.8 | 68 |
| A2 | Ethylene-acrylic acid | 10.9 | 89 |
| | copolymer | | |
| A3 | Ethylene-methacrylic | 10.9 | 89 |
| | acid copolymer | | |
| A4 | Styrene-acrylic acid | 10.6 | 66 |
| | copolymer | | |
| A5 | Styrene-methacrylic | 10.5 | 67 |
| | acid copolymer | | |

As compared with Battery A1, which used polyacrylic acid as the binder, Batteries A2 and A3, which used an ethylene-acrylic acid copolymer and an ethylene-methacrylic acid copolymer, exhibited an improved capacity retention rate.

Batteries A2 and A3 used resin materials having higher flexibility than polyacrylic acid as the binder. It seems that the stress applied to the binder due to the volume change of the negative electrode active material was therefore reduced during the charge/discharge cycles, thus suppressing destruction of the binding structure.

Furthermore, Batteries A2 and A3 exhibited good characteristics also as compared with Batteries A4 and A5, which used a styrene-acrylic acid copolymer and a styrene-methacrylic acid copolymer. Polystyrene composed only of styrene units is a solid resin, although it is amorphous. Therefore, it seems that the styrene-acrylic acid copolymer and the styrene-methacrylic acid copolymer that include a styrene unit had insufficient flexibility.

It should be noted that mixing a thickener, including, for example, CMC with the negative electrode material mixture slurry will not change the basic physical properties of the copolymers serving as the binder. Therefore, when a thickener is included in the slurry as an optional component, it is also possible to achieve, to varying degrees, a similar effect.

### Example 2

Batteries B1 to B9 and Batteries C1 to C9 were produced in the same manner as with Batteries A2 and A3 of Example 1, except that the contents of the acrylic acid unit and the methacrylic acid unit in the ethylene-acrylic acid copolymer and the ethylene-methacrylic acid copolymer were varied as shown in Table 2 (85 mol %, 82 mol %, 80 mol %, 60 mol %, mol %, 10 mol %, 4 mol %, 3 mol % or 2 mol %). The obtained batteries were evaluated in the same manner as in Example 1. The results are shown in Table 2.

TABLE 2
Binder: Ethylene-acrylic acid copolymer

| | Acrylic acid unit | Initial capacity | Capacity retention |
|---|---|---|---|
| Battery | content (mol/%) | (mAh) | rate (%) |
| B1 | 85 | 10.8 | 77 |
| B2 | 82 | 10.9 | 80 |
| B3 | 80 | 10.9 | 86 |
| B4 | 60 | 10.9 | 90 |
| B5 | 40 | 10.9 | 90 |
| B6 | 10 | 10.9 | 89 |
| B7 | 4 | 10.8 | 87 |
| B8 | 3 | 10.7 | 78 |
| B9 | 2 | 10.5 | 75 |

Binder: Ethylene-methacrylic acid copolymer

| | Methacrylic acid unit | Initial capacity | Capacity retention |
|---|---|---|---|
| Battery | content (mol/%) | (mAh) | rate (%) |
| C1 | 85 | 10.7 | 71 |
| C2 | 82 | 10.8 | 76 |
| C3 | 80 | 10.9 | 85 |
| C4 | 60 | 10.9 | 89 |
| C5 | 40 | 10.9 | 90 |
| C6 | 10 | 10.9 | 89 |
| C7 | 4 | 10.7 | 87 |
| C8 | 3 | 10.6 | 78 |
| C9 | 2 | 10.5 | 75 |

When the content of the acrylic acid unit included in the ethylene-acrylic acid copolymer was in the range of 80 mol % to 4 mol %, more preferable results were obtained. Similarly, when the content of the methacrylic acid unit included in the ethylene-methacrylic acid copolymer was in the range of 80 mol % to 4 mol %, more preferable results were obtained. It seems that the flexibility of the binders was relatively reduced when the contents of the acrylic acid unit and the methacrylic acid unit exceeded 80 mol %, and the binding force was relatively reduced when they were less than 4 mol %.

### Example 3

Batteries D1 to D6 and Batteries E1 to E6 were produced in the same manner as with Batteries A2 and A3 of Example 1, except that the amount of the ethylene-acrylic acid copolymer or the ethylene-methacrylic acid copolymer occupying the negative electrode material mixture (i.e., the total of the Ti—Si alloy, the binder and the conductive agent) was varied as shown in Table 3 (30 wt %, 25 wt %, 20 wt %, 1 wt %, 0.5 wt % or 0.3 wt %). The amounts of the Ti—Si alloy and the conductive agent were the same as those in Example 1. The obtained batteries were evaluated in the same manner as in Example 1. The results are shown in Table 3.

TABLE 3

| | | | |
|---|---|---|---|
| | Binder content | Initial capacity | Capacity retention |
| Battery | (wt/%) | (mAh) | rate (%) |

Binder: Ethylene-acrylic acid copolymer

| | | | |
|---|---|---|---|
| D1 | 30 | 5.7 | 92 |
| D2 | 25 | 8.6 | 91 |
| D3 | 20 | 10.4 | 90 |
| D4 | 1 | 10.9 | 87 |
| D5 | 0.5 | 10.6 | 85 |
| D6 | 0.3 | 10.3 | 72 |

Binder: Ethylene-methacrylic acid copolymer

| | | | |
|---|---|---|---|
| E1 | 30 | 5.5 | 91 |
| E2 | 25 | 8.5 | 90 |
| E3 | 20 | 10.3 | 89 |
| E4 | 1 | 10.9 | 87 |
| E5 | 0.5 | 10.6 | 85 |
| E6 | 0.3 | 10.2 | 73 |

When the contents of the ethylene-acrylic acid copolymer and the ethylene-methacrylic acid copolymer included in the negative electrode material mixture were in the range of 0.5 wt % to 20 wt %, more preferable results were obtained. It seems that the ratio of the portion of the active material particles surface that was covered with the binder increased when the content of the binder exceeded 20 wt %. On the other hand, it seems that the binding force was reduced when the content of the binder was less than 0.5%, since the amount of the binder was small.

### Example 4

In this example, a case is described where the negative electrode material mixture carried on the current collector was rolled under heating at the time of production of the negative electrode.

Batteries F1 to F7 and Batteries G1 to G7 were produced in the same manner as with Batteries A2 and A3 of Example 1, except that the heating temperature was varied as shown in Table 4 (50° C., 55° C., 60° C., 100° C., 150° C., 155° C. or 160° C.) at the time of rolling the negative electrode material mixture carried on the current collector. The obtained batteries were evaluated in the same manner as in Example 1. The results are shown in Table 4.

TABLE 4

| | | | |
|---|---|---|---|
| | Heating temperature | Initial capacity | Capacity retention |
| Battery | during rolling (° C.) | (mAh) | rate (%) |

Binder: Ethylene-acrylic acid copolymer

| | | | |
|---|---|---|---|
| F1 | 50 | 10.9 | 89 |
| F2 | 55 | 10.9 | 89 |
| F3 | 60 | 10.9 | 90 |
| F4 | 100 | 10.9 | 92 |
| F5 | 150 | 10.5 | 91 |
| F6 | 155 | 9.3 | 89 |
| F7 | 160 | 7.4 | 87 |

Binder: Ethylene-methacrylic acid copolymer

| | | | |
|---|---|---|---|
| G1 | 50 | 10.9 | 89 |
| G2 | 55 | 10.9 | 89 |
| G3 | 60 | 10.9 | 90 |
| G4 | 100 | 10.9 | 91 |
| G5 | 150 | 10.4 | 92 |
| G6 | 155 | 9.1 | 91 |
| G7 | 160 | 6.9 | 89 |

The preferable heating temperature during rolling of the negative electrode material mixtures including the ethylene-acrylic acid copolymer and the ethylene-methacrylic acid copolymer was in the range of 60° C. to 150° C. It seems that the softening of the copolymers was insufficient when the heating temperature during rolling was less than 60° C., and when it exceeded 150° C., fluidization of the copolymers occurred in the negative electrode material mixtures, thus making the material mixture nonuniform.

### Example 5

In this example, a case is described where the negative electrode material mixture carried on the current collector was rolled at room temperature followed by heating, at the time of production of the negative electrode.

Batteries H1 to H7 and Batteries I1 to I7 were produced in the same manner as with Batteries A2 and A3 of Example 1, except that negative electrode sheets obtained by rolling the negative electrode material mixtures at room temperature were heated at the temperatures shown in Table 5 (50° C., 55° C., 60° C., 100° C., 150° C., 155° C. or 160° C.) for five minutes. The obtained batteries were evaluated in the same manner as in Example 1. The results are shown in Table 5.

TABLE 5

| | | | |
|---|---|---|---|
| | Heating temperature | Initial capacity | Capacity retention |
| Battery | after rolling (° C.) | (mAh) | rate (%) |

Binder: Ethylene-acrylic acid copolymer

| | | | |
|---|---|---|---|
| H1 | 50 | 10.9 | 89 |
| H2 | 55 | 10.9 | 89 |
| H3 | 60 | 10.9 | 90 |
| H4 | 100 | 10.9 | 92 |
| H5 | 150 | 10.7 | 91 |
| H6 | 155 | 9.5 | 88 |
| H7 | 160 | 7.7 | 85 |

Binder: Ethylene-methacrylic acid copolymer

| | | | |
|---|---|---|---|
| I1 | 50 | 10.9 | 89 |
| I2 | 55 | 10.9 | 89 |
| I3 | 60 | 10.9 | 90 |
| I4 | 100 | 10.9 | 91 |
| I5 | 150 | 10.5 | 92 |
| I6 | 155 | 9.3 | 90 |
| I7 | 160 | 7.1 | 87 |

The preferable heating temperature for the negative electrode sheets including the ethylene-acrylic acid copolymer and the ethylene-methacrylic acid copolymer was 60° C. to 150° C. It seems that the softening of the copolymers was insufficient when the heating temperature for the negative electrode sheets was less than 60° C., and when it exceeded 150° C., fluidization of the copolymers occurred in the negative electrode material mixtures, thus making the material mixture nonuniform.

It should be noted that the heating treatment of the negative electrode material mixture may be carried out at any time after the negative electrode material mixture has been carried on the current collector. However, it is preferable to heat the negative electrode material mixture while rolling, or to heat it after rolling, and either of these provides a similar effect.

### Example 6

In this example, a case is described where an M¹-Si alloy (M¹ is Fe, Co, Ni or Cu) or an M²-Sn alloy (M² is Ti or Cu) was used as the negative electrode active material.

Preparation of Each Alloy Powder was Performed by a mechanical alloying process as in Example 1. The alloy compositions are shown below.

Fe—Si alloy (Fe: 37 wt %, Si: 63 wt %)
Co—Si alloy (Co: 38 wt %, Si: 62 wt %)
Ni—Si alloy (Ni: 38 wt %, Si: 62 wt %)
Cu—Si alloy (Cu: 39 wt %, Si: 61 wt %)
Ti—Sn alloy (Ti: 26 wt %, Sn: 74 wt %)
Cu—Sn alloy (Cu: 31 wt %, Sn: 69 wt %)

An analysis of each of the obtained alloys by an electron diffraction method using a transmission electron microscope apparatus confirmed that it was an alloy comprising two phases of an M¹Si₂ alloy and Si, or an alloy comprising two phases of an M²₆Sn₅ alloy and Sn.

Batteries J1 to J6 and Batteries K1 to K6 were produced in the same manner as with Batteries A2 and A3 of Example 1, except the above-described alloy powders were used. Here, the weight of the active material included in the negative electrode was set to 15 mg in the case of using an M¹-Si alloy, and the weight of the active material included in the negative electrode was set to 60 mg in the case of using an M²-Sn alloy. The obtained batteries were evaluated in the same manner as in Example 1. The results are shown in Table 6.

TABLE 6

| | Ethylene-acrylic | Initial capacity | Capacity retention |
|---|---|---|---|
| Battery | acid copolymer | (mAh) | rate (%) |
| J1 | Fe 37 wt %-Si 63 | 9.9 | 88 |
| | wt % alloy | | |
| J2 | Co 38 wt %-Si 62 | 9.7 | 89 |
| | wt % alloy | | |
| J3 | Ni 38 wt %-Si 62 | 9.7 | 89 |
| | wt % alloy | | |
| J4 | Cu 39 wt %-Ni 61 | 9.1 | 87 |
| | wt % alloy | | |
| J5 | Ti 26 wt %-Sn 74 | 10.5 | 88 |
| | wt % alloy | | |
| J6 | Cu 31 wt %-Sn 69 | 10.1 | 87 |
| | wt % alloy | | |
| | Ethylene-methacrylic | Initial capacity | Capacity retention |
| Battery | acid copolymer | (mAh) | rate (%) |
| K1 | Fe 37 wt %-Si 63 | 9.9 | 88 |
| | wt % alloy | | |
| K2 | Co 38 wt %-Si 62 | 9.7 | 89 |
| | wt % alloy | | |
| K3 | Ni 38 wt %-Si 62 | 9.7 | 89 |
| | wt % alloy | | |
| K4 | Cu 39 wt %-Ni 61 | 9.1 | 87 |
| | wt % alloy | | |
| K5 | Ti 26 wt %-Sn 74 | 10.5 | 88 |
| | wt % alloy | | |
| K6 | Cu 31 wt %-Sn 69 | 10.1 | 87 |
| | wt % alloy | | |

In this example, use of each of the alloys achieved the capacity retention rate equivalent to that obtained in Example 1, which used a Ti—Si alloy. Therefore, it was possible to confirm that the effect of the present invention can be achieved irrespective of the kind of the transition metal.

### Example 7

In this example, a case is described where the amount of Si in the negative electrode active material was varied. Here, description is given of Ti—Si alloys.

Ti—Si alloys were prepared by a mechanical alloying process in the same manner as in Example 1, except that the composition was varied as shown below.

Ti 9 wt %—Si 91 wt % alloy (Ti: 9 wt %, Si: 91 wt %)
Ti 23 wt %—Si 77 wt % alloy (Ti: 23 wt %, Si: 77 wt %)
Ti 41 wt %—Si 59 wt % alloy (Ti: 41 wt %, Si: 59 wt %)

An analysis of each of the obtained alloys by an electron diffraction method using a transmission electron microscope apparatus confirmed that it was an alloy comprising two phase of a TiSi₂ alloy and Si.

Batteries L1 to L3 and Batteries M1 to M3 were produced in the same manner as with Batteries A2 and A3 of Example 1, except that the above-described alloy powders were used. Here, the amount of the active material included in the negative electrode was set to 4 mg for the Ti 9 wt %-Si 91 wt % alloy, 6 mg for the Ti 23 wt %-Si 77 wt % alloy, and 30 mg for the Ti 41 wt %-Si 59 wt % alloy. The obtained batteries were evaluated in the same manner as in Example 1. The results are shown in Table 7.

TABLE 7

| | Ethylene-acrylic | Initial capacity | Capacity retention |
|---|---|---|---|
| Battery | acid copolymer | (mAh) | rate (%) |
| L1 | Ti 9 wt %-Si 91 | 11.2 | 86 |
| | wt % alloy | | |
| L2 | Ti 23 wt %-Si 77 | 10.5 | 88 |
| | wt % alloy | | |
| L3 | Ti 41 wt %-Si 59 | 10.6 | 93 |
| | wt % alloy | | |
| | Ethylene-methacrylic | Initial capacity | Capacity retention |
| Battery | acid copolymer | (mAh) | rate (%) |
| M1 | Ti 9 wt %-Si 91 | 11.2 | 86 |
| | wt % alloy | | |
| M2 | Ti 23 wt %-Si 77 | 10.5 | 88 |
| | wt % alloy | | |
| M3 | Ti 41 wt %-Si 59 | 10.6 | 93 |
| | wt % alloy | | |

Although the initial capacity varies according to the composition of the alloy, similar characteristics were achieved for each case with regard to the cycle characteristics, so that the effect of improving the cycle characteristics especially at a low temperature can be achieved by using the ethylene-acrylic acid copolymer, and the ethylene-methacrylic acid copolymer, regardless of the Si content in the alloy.

### Example 8

In this example, silicon oxide (SiO) and tin oxide (SnO) were used as the negative electrode active material. A SiO powder (average particle diameter 75 μm) manufactured by Kojundo Chemical Laboratory Co., Ltd. was used as SiO. A SnO powder manufactured by Kojundo Chemical Laboratory Co., Ltd. was uses as SnO.

Batteries N1 to N5 and O1 to O5 were produced in the same manner as with Batteries A1 to A5 of Example 1, except that the above-described oxide powders were used. Here, the amount of the active material included in the negative electrodes was set to 5 mg for SiO, and 17 mg for SnO. The thickness of the positive electrode was controlled such that it was in sufficient excess, in consideration of the initial irreversible capacities of SiO and SnO. The obtained batteries were evaluated in the same manner as in Example 1. The results are shown in Table 8.

TABLE 8

| | | | |
|---|---|---|---|
| | | Initial capacity | Capacity retention |
| Battery | Binder | (mAh) | rate (%) |

Active material: SiO powder

| | | | |
|---|---|---|---|
| N1 | Polyacrylic acid | 10.0 | 62 |
| N2 | Ethylene-acrylic acid | 10.1 | 88 |
| | copolymer | | |
| N3 | Ethylene-methacrylic acid | 10.0 | 87 |
| | copolymer | | |
| N4 | Styrene-acrylic acid | 9.8 | 59 |
| | copolymer | | |
| N5 | Styrene-methacrylic acid | 9.7 | 60 |
| | copolymer | | |

Active material: SnO powder

| | | | |
|---|---|---|---|
| O1 | Polyacrylic acid | 9.5 | 61 |
| O2 | Ethylene-acrylic acid | 9.7 | 87 |
| | copolymer | | |
| O3 | Ethylene-methacrylic acid | 9.6 | 87 |
| | copolymer | | |
| O4 | Styrene-acrylic acid | 9.5 | 59 |
| | copolymer | | |
| O5 | Styrene-methacrylic acid | 9.5 | 59 |
| | copolymer | | |

As shown above, it is seen that the cycle characteristics were improved especially at a low temperature by using the ethylene-acrylic acid copolymer and the ethylene-methacrylic acid copolymer also in the cases of using a SiO powder and a SnO powder as the negative electrode active material, as in the case of using an alloy.

### Example 9

In this example, a case is described where the battery was heated in the initial charged state after production of the battery, without performing heating of the negative electrode material mixture at the time of production of the negative electrode.

Plural pieces each of batteries that were the same as Batteries A2 and A3 of Example 1 were produced (Batteries P1 to P6 and Q1 to Q6), and they were subjected to 100 charge/discharge cycles at 0° C. under the same condition as in Example 1. Here, after completion of the 1st charging, the batteries in a charged state were heated at the temperatures shown in Table 9 (50° C., 55° C., 60° C., 90° C., 95° C. or 100° C.) for 30 minutes. Then, as in Example 1, the ratio of the discharge capacity at the 100th cycle to the initial capacity was determined as the capacity retention rate. The results are shown in Table 9, together with the initial capacity.

TABLE 9

| | | | |
|---|---|---|---|
| | Battery heating | Initial capacity | Capacity retention |
| Battery | temperature (° C.) | (mAh) | rate (%) |

Binder: Ethylene-acrylic acid copolymer

| | | | |
|---|---|---|---|
| P1 | 50 | 10.8 | 89 |
| P2 | 55 | 10.8 | 89 |
| P3 | 60 | 10.8 | 90 |
| P4 | 90 | 10.8 | 92 |
| P5 | 95 | 10.8 | 82 |
| P6 | 100 | 10.8 | 79 |

Binder: Ethylene-methacrylic acid copolymer

| | | | |
|---|---|---|---|
| Q1 | 50 | 10.8 | 89 |
| Q2 | 55 | 10.8 | 89 |
| Q3 | 60 | 10.8 | 90 |
| Q4 | 90 | 10.8 | 91 |
| Q5 | 95 | 10.8 | 80 |
| Q6 | 100 | 10.8 | 78 |

As shown above, the preferable heating temperature for the batteries in a charged state was 60° C. to 90° C. It seems that, when the heating temperature was less than 60° C., the softening of the copolymers was insufficient, so that the effect of heating could not be achieved sufficiently. On the other hand, when the heating temperature exceeded 90° C., the side reaction between the constituent materials (the non-aqueous electrolyte and the electrode active material) of the battery was promoted, thus possibly degrading the battery characteristics. It should be noted that the heating treatment of the battery is preferably performed in the initial charged state.

### INDUSTRIAL APPLICABILITY

The present invention is useful for a lithium ion secondary battery that is required to achieve both high energy density and excellent cycle characteristics at the same time. The lithium ion secondary battery according to the present invention can be used for, but without any particular limitation, portable information terminals, portable electronic devices (e.g., a mobile phone and a notebook computer), electric power storage devices for household use, two-wheeled motor vehicles, electric vehicles and hybrid electric vehicles, and so on.

1. A negative electrode for a lithium ion secondary battery, comprising:
a negative electrode material mixture including an active material powder capable of reversibly absorbing and desorbing lithium, and a binder,
wherein said active material includes at least one element selected from the group consisting of Si and Sn, and
said binder includes at least one selected from the group consisting of an ethylene-acrylic acid copolymer and an ethylene-methacrylic acid copolymer,
a content of an acrylic acid unit included in said ethylene-acrylic acid copolymer is 4 mol % to 80 mol % and
a content of a methacrylic acid unit included in said ethylene-acrylic acid copolymer is 4 mol % to 8 mol %.

2. The negative electrode for a lithium ion secondary battery in accordance with claim 1,
wherein said active material comprises an alloy of Si and a transition metal, and said transition metal is at least one selected from the group consisting of Ti, Fe, Co, Ni and Cu.

3. The negative electrode for a lithium ion secondary battery in accordance with claim 1,
wherein said active material comprises an oxide including at least one element selected from the group consisting of Si and Sn.

4-5. (canceled)

6. The negative electrode for a lithium ion secondary battery in accordance with claim 1,
wherein a content of said binder in said negative electrode material mixture is 0.5 wt % to 20 wt %.

7. A lithium ion secondary battery comprising:
a chargeable and dischargeable positive electrode;
the negative electrode according to claim 1; and a non-aqueous electrolyte.

8. A method for producing a negative electrode for a lithium ion secondary battery, said method comprising:
(i) preparing a slurry by mixing, with a liquid dispersion medium, a negative electrode material mixture including an active material powder capable of reversibly absorbing and desorbing lithium, and a binder,
wherein said active material includes at least one element selected from the group consisting of Si and Sn, and said binder includes at least one selected from the group consisting of an ethylene-acrylic acid copolymer and an ethylene-methacrylic acid copolymer;
(ii) applying said slurry to a substrate, followed by drying, thereby forming a negative electrode material mixture layer; and
(iii) rolling said negative electrode material mixture under heating, or rolling said negative electrode material mixture followed by heating,
wherein a content of an acrylic acid unit included in said ethylene-methacrylic acid copolymer is 4 mol % to 80 mol % and
a content of a methacrylic acid unit included in said ethylene-methacrylic acid copolymer is 4 mol % to 80 mol %.

9. The method for producing a negative electrode for a lithium ion secondary battery in accordance with claim 8,
wherein a temperature for said heating is not less than 60° C. and not more than 150° C.

10. A method for producing a lithium ion secondary battery, said method comprising:
(a) forming an electrode group comprising a positive electrode and the negative electrode according to claim 1;
(b) housing said electrode group in a battery case having an opening;
(c) impregnating said electrode group with a non-aqueous electrolyte in said battery case;
(d) sealing said opening of said battery case, thereby forming a battery; and
(e) heating said battery in a charged state.

11. The method for producing a lithium ion secondary battery in accordance with said claim 10,
wherein a temperature for said heating is not less than 60° C. and not more than 90° C.
